(19) United States
(12) Patent Application Publication
(10) Pub. No.: US 2001/0003707 A1
(43) Pub. Date: Jun. 14, 2001

(54) PORTABLE RADIO APPARATUS WITH ADDITIONAL DISPLAY UNIT

(76) Inventor: TAKASHIRO MORIYA, TOKYO (JP)

Correspondence Address: YOUNG & THOMPSON, 745 SOUTH 23RD STREET 2ND FLOOR, ARLINGTON, VA, 22202

(21) Appl. No.: 09/132,330

(22) Filed: Aug. 11, 1998

(30) Foreign Application Priority Data
Aug. 11, 1997 (JP) 216417/1997

(51) Int. Cl. H04M 1/00

(52) U.S. Cl. 455/566; 455/556; 455/550; 455/575; 455/90; D14/138; D14/240; D14/244; D14/130

(57) ABSTRACT

A portable radio apparatus includes a housing. A display section, a speech receiving section, a speech transmitting section and a key operation section are provided on a front surface of the housing. An additional display section is provided on at least one of surfaces which are different from the front surface of the housing.

### BACKGROUND OF THE INVENTION

1. Field of the Invention

The present invention relates to a portable radio apparatus, and more particularly, to a portable radio apparatus with a display unit provided on a front surface and an additional display unit.

2. Description of the Related Art

Generally, a portable radio apparatus has a housing, and a radio unit, a speech receiving section, a speech transmitting section, a key operation section, a display section and so on are arranged on the housing. In such a portable radio apparatus, the speech receiving section and the speech transmitting section need to be positioned on the positions corresponding to the ear and mouth of the user in the communication state. Therefore, the portable radio apparatus has a considerable large size in case of a single housing of a slab or plate manner. As a result, there is a problem in that the portability of the portable radio apparatus is low.

For this reason, a portable radio apparatus is provided in which one of two housings is provided with a speech receiving section and the other of the two housings is provided with a speech transmitting section. In such a portable radio apparatus, two housings are assembled via a hinge section such that the two housings can be opened or closed. The two housings are folded in the carrying state and opened in the using state.

For example, such a folded type portable radio apparatus is described in Japanese Laid Open Patent Application (JP-A-Heisei 4-307841). FIG. 1 is a perspective view illustrating an example of the folded type portable radio apparatus.

As shown in FIG. 1, the conventional folded type portable radio apparatus is composed of a first housing section 110 and a second housing section 120. The first housing section 110 is provided with a speech transmitting section 111 which has a transmitter and a key operation section 112. The second housing section 120 is attached to the upper end of the first housing section 110 through a hinge section 130 such that they can be freely opened and closed. The second housing section 120 is provided with a speech receiving section 121 which has a receiver and a display section 122 for displaying predetermined data.

As shown in FIG. 1, in the conventional portable radio apparatus having such a structure, the second housing section 120 can be rotated into the direction of \mathring{1} in FIG. 1. As a result, the second housing section 120 is folded and accommodated in the position corresponding to the key operation section 112 of the first housing section 110. Thus, the portability can be improved. It should be noted that the key operation part 112, the speech receiving section 121, and the display section 122 are all hidden in the state in which the second housing section 120 is folded.

When the second housing section 120 is rotated into the direction of \mathring{2} in FIG. 1, the second housing section 120 is opened or developed upward of the first housing section 110. As a result, the key operation section 112, and the speech receiving section 121, and the display section 122 are exposed to allow the portable radio apparatus to be set to the state in which it is possible to communicate.

A portable radio apparatus needs to be manufactured to have a small size for improvement of the portability so that it became difficult to secure the sufficiently large size for the display section. However, in the conventional folded type portable radio apparatus, there is a limit to the size of the display section. Therefore, the conventional folded type portable radio apparatus cannot display a large quantity of data at a time. Thus, it is necessary to add a function to scroll a screen to the display section. As a result, the radio apparatus becomes complicated and takes a high cost.

Also, as shown in FIG. 1, in the conventional folded type portable radio apparatus, all of the sections such as the display section, the key operation section, the speech receiving section and the speech transmitting section are arranged on the same front surface of the housing in the opened state. Therefore, in the state in which the two housing sections are folded, the display section and the key operation section are hidden inside the housings. Therefore, it is impossible to see a necessary data on the display section and to perform an input operation, as far as the two housing sections are not opened. Thus, there is a disadvantageous inconvenience in the aspect of the operability.

On the other hand, sections such as the display section and the key operation section are not provided at all on the back surfaces of the housing sections of the portable radio apparatus. That is, the back surfaces of the housing sections are a free space.

A display apparatus is described in Japanese Laid Open Patent Application (JP-A-Heisei 4-298878). In this reference, a first housing section 2 and a second housing section 12 are formed such that they can be folded. When the second housing section 12 is opened, an LCD section 13a of the first housing section 2 and an LCD section 13b of the first housing section 12 are integrated as a single display section so that one large screen display section is formed. In this reference, however, the back surface of the display apparatus is not effectively used.

A portable electronic equipment is described in Japanese Laid Open Utility Model Application (JP-U-Heisei 5-30918). In this reference, the portable electronic equipment is composed of a key board 2, and a cover section 11 which is formed of two display sections 11a and 11b which are folded to cover the key board 2. In this reference, the screen size of the display section can be made wide. However, the structure is complicated so that the manufacturing cost becomes high. Also, the two display sections 11a and 11b are provided on the front surface of the equipment in the opened state.

A folded type liquid crystal display apparatus is described in Japanese Laid Open Patent Application (JP-A-Heisei 7-93125). In this reference, in the same manner as described above, two display sections connected to each other via a hinge section and opened to form a wide screen.

A folded type portable personal computer is described in Japanese Laid Open Utility Model Application (JP-U-Heisei 5-43218). In this reference, in the same manner as described above, two display sections connected to each other via a hinge section and opened to form a wide screen. The two display sections are provided on the front surface in the opened state.

### SUMMARY OF THE INVENTION

The present invention is accomplished to solve the problems in the above conventional technique. Therefore, an object of the present invention is to provide a portable radio apparatus in which the free space of a housing or housing sections of the portable radio apparatus is effectively utilized.

Another object of the present invention is to provide a portable radio apparatus in which a display section is provided on surfaces of the housing or housing sections other than the front surface.

Still another object of the present invention is to provide a portable radio apparatus in which it possible to display a large quantity of data at a time.

Yet still another object of the present invention is to provide a folded type portable radio apparatus in which a display section can be used in the state in which the folded type portable radio apparatus is folded.

In order to achieve an aspect of the present invention, a portable radio apparatus includes a display section, a speech receiving section, a speech transmitting section and a key operation section are provided on a front surface of a housing, and an additional display section provided on at least one of surfaces which are different from the front surface of the housing.

At least one of the surfaces which are different from the front surface of the housing may be a back surface of the housing. The additional display section has a data inputting function.

The housing may include a first housing section in which the speech receiving section is provided on a front surface of the first housing section, a second housing section in which the speech transmitting section is provided on a front surface of the second housing section, and a hinge section for connecting the first and second housing sections such that the first and second housing sections can be folded and opened. In this case, the additional display section may be provided on a back surface of one of the first and second housing sections. Also, the additional display section may have a data inputting function.

When the additional display section comprises first and second display sections, the first and second display sections may be respectively provided on back surfaces of the first and second housing sections. In this case, at least one of the first and second display sections has a data inputting function.

In order to achieve another aspect of the present invention, a folded type portable radio apparatus includes a first housing section in which at least one of a first display section and key operation section is provided on a front surface of the first housing section, a second housing section having a second display section, and a hinge section for connecting the first and second housing sections such that the first and second housing sections can be folded and opened. The second display section is provided such the second display section can be seen in a folded state of the first and second housing sections.

### BRIEF DESCRIPTION OF THE DRAWINGS

FIG. 1 is a perspective view of an example of a conventional folded type portable radio apparatus;

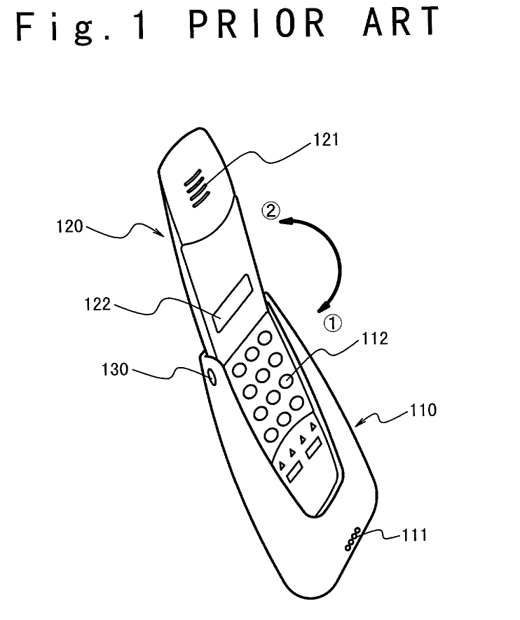

FIG. 2 is a perspective view of a portable radio apparatus according to a first embodiment of the present invention when the portable radio apparatus is seen from the front side;

FIG. 3 is a perspective view of the portable radio apparatus according to the first embodiment of the present invention when the portable radio apparatus is seen from the back side;

FIG. 4 is a perspective view of the portable radio apparatus according to the second embodiment of the present invention when the portable radio apparatus is seen from the front side;

FIG. 5 is a perspective view of the portable radio apparatus according to the second embodiment of the present invention when the portable radio apparatus is seen from the back side;

FIG. 6 is a perspective view of the portable radio apparatus according to a third embodiment of the present invention when the portable radio apparatus is seen from the back side; and

FIG. 7 is a perspective view of the portable radio apparatus according to a fourth embodiment of the present invention when the portable radio apparatus is seen from the back side.

### DESCRIPTION OF THE PREFERRED EMBODIMENTS

The portable radio apparatus of the present invention will be described with reference to the attached drawings.

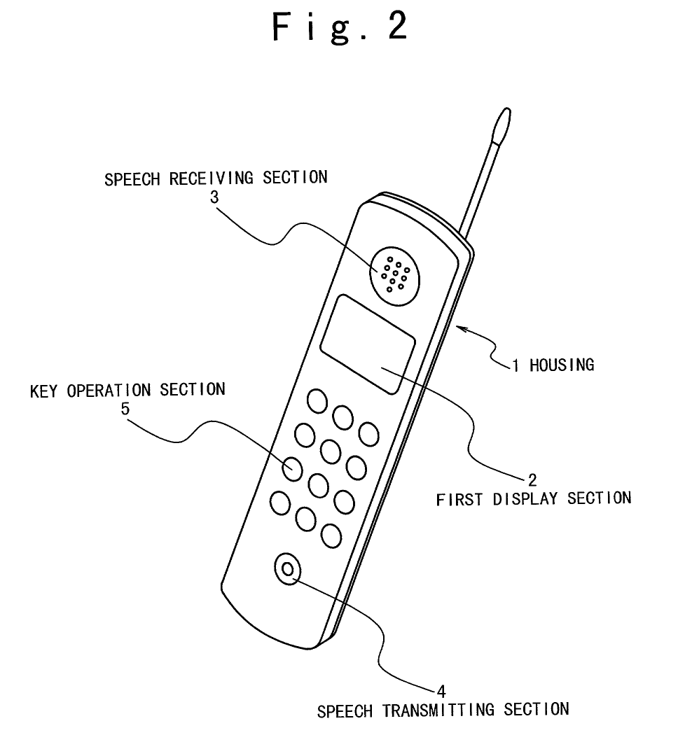

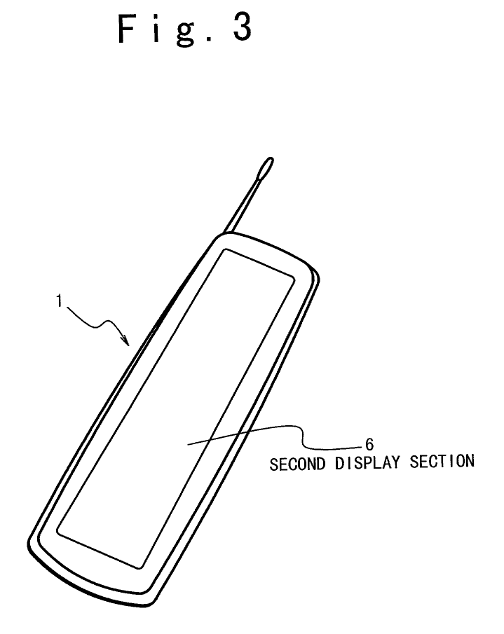

First, the portable radio apparatus according to the first embodiment of the present invention will be described with reference to FIGS. 2 and 3. FIG. 2 is a perspective view of the portable radio apparatus in the first embodiment when the portable radio apparatus is seen from the front side. FIG. 3 is a perspective view of the portable radio apparatus in the first embodiment when the portable radio apparatus is seen from the back side.

As shown in FIGS. 2 and 3, the portable radio apparatus according to the first embodiment is such as a portable telephone and PHS. The portable radio apparatus is composed of a housing 1 which is the main body of the radio apparatus. The housing section 1 is provided with a display section 2, a speech receiving section 3, a speech transmitting section 4 and a key operation section 5 on the front surface of the housing 1. A radio unit (not illustrated) is provided in the housing 1. Also, another display section 6 which is different from the display section 2 is further provided on a surface different from the front surface of the housing 1, that is, on the back surface of the housing 1 in this embodiment. The other display section 6 may be driven selectively based on the operation of the key operation section 5. Or, the other display section 6 may be driven at the same time as the display section 2 to display the same data as in the display section 2 or the subsequent or preceding data to the data displayed on the display section 2.

According to the portable radio apparatus of the first embodiment having such a structure, the other display section 6 is provided on the surface which is different from the front surface. Accordingly, the portable radio apparatus can be operated while necessary and minimum data is displayed on the display section 2 on the front surface. Also, since the other display section 6 with a large screen is arranged on the back surface of the housing 1, a large quantity of data can be displayed on the other display section 6 at a time. Especially, since the back surface of the housing 1 with a large area can be effectively used as a free space, the display section 6 with the large screen can be provided so that the large quantity of data can be displayed at a time.

In the first embodiment, the other display section 6 is provided on the back surface of the housing 1. However, it should be noted that the other display section 6 may be provided on any surface which is different from the front surface of the housing 1, otherwise. The surface is not limited to the back surface. For example, the other display section 6 may be provided for the end surface of the housing section 1 in the longitudinal direction.

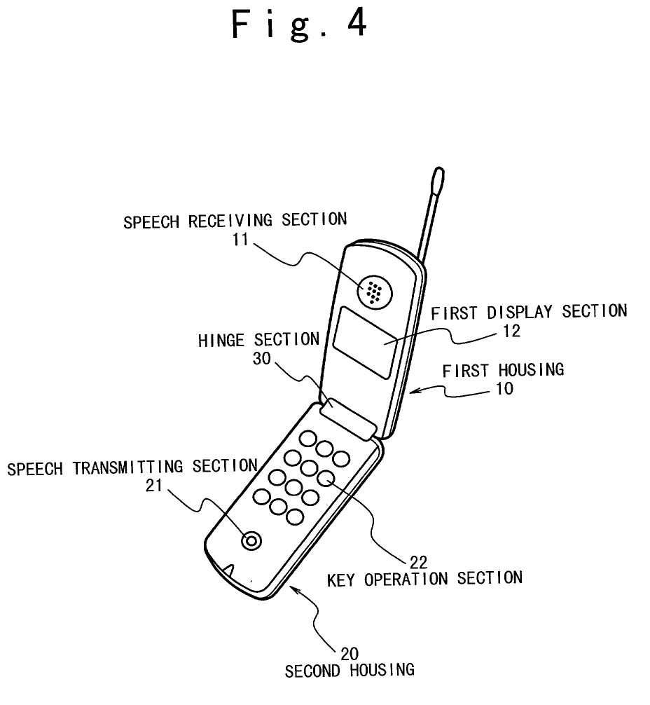

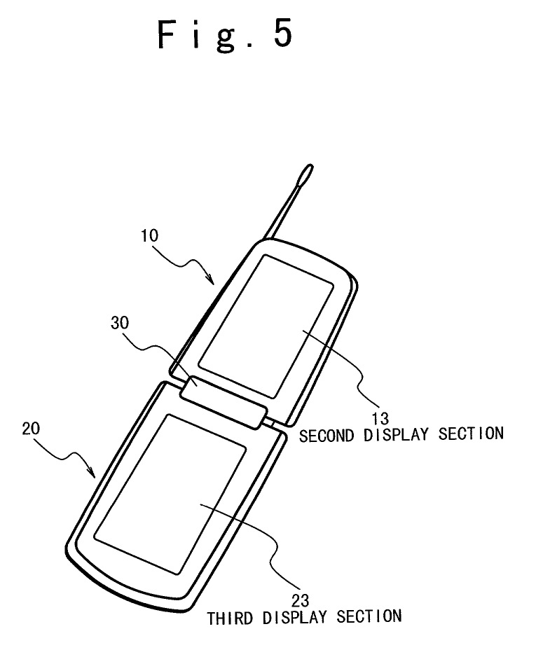

Next, the portable radio apparatus according to the second embodiment of the present invention will be described with reference to FIGS. 4 and 5. FIG. 4 is a perspective view of the portable radio apparatus of the second embodiment of the present invention when the portable radio apparatus is seen from the front surface. FIG. 5 is a perspective view of the portable radio apparatus of the second embodiment of the present invention when the portable radio apparatus is seen from the back surface.

As shown in FIGS. 4 and 5, in the second embodiment, the housing of the portable radio apparatus is composed of two independent housing sections, i.e., a first housing section 10 and the second housing section 20. These two housing sections 10 and 20 are connected by a hinge section 30 such that these housing sections 10 and 20 can be rotated to form the folded type portable radio apparatus.

The first housing section 10 is provided with a speech receiving section 11 and a first display section 12. The second housing section 20 which is connected to the first housing section 10 via the hinge section 30 such that the first and second housing sections 10 and 20 can be folded or opened. The second housing section 20 is provided with a speech transmitting section 21 and a key operation section 22.

Then, the respective back surfaces of the first and second housing sections 10 and 20 are provided with second and third display sections 13 and 23, respectively. In the second embodiment, these second and third display sections 13 and 23 are composed of liquid crystal display sections, respectively.

In this way, in the folded type portable radio apparatus, since the second and third display sections 13 and 23 are provided for the back surfaces of the first and second housing sections 10 and 20, necessary data can be displayed on the second and third display sections 13 and 23 in the state in which the first housing section 10 and the second housing section 20 are folded. As a result, the necessary data can be confirmed without opening the radio apparatus. Also, since the back surfaces of the first and second housing sections 10 and 20 are used in this way, the second and third display sections 13 and 23 can be formed to have a large size of screen so that a large quantity of data can be displayed at a time.

It should be noted that in the second embodiment, only one of the second and third display sections 13 and 23 may be provided to the back surface of the corresponding one of the first housing section 10 or the second housing section 20.

Also, in the second embodiment, the second and third display sections 13 and 23 are provided on the back surfaces of the first and second housing sections 10 and 20. However, the second and third display sections 13 and 23 may be provided on, for example, the end surface of the first or second housing section 10 or 20 into the longitudinal direction.

Moreover, the second and third display sections 13 and 23 may be composed of liquid crystal display sections. In this case, the second and third display sections 13 and 23 are desirably formed as touch input enable devices. Thus, the operation as the portable radio apparatus can be made possible in the state in which the first and second housing sections 10 and 20 are folded. This can be applied to the first embodiment.

According to the portable radio apparatus of the second embodiment in this way, the second and third display sections 13 and 23 are provided on the back surfaces of the first and second housing sections 10 and 20 of the folded type portable radio apparatus. Therefore, the back surfaces of the housing sections of the folded type portable radio apparatus can be effectively used as a free space so that a large quantity of data can be displayed at a time without compromising the portability and operability of the folded type portable radio apparatus.

In the state in which the folded type portable radio apparatus is folded, the second and third display sections 13 and 23 which are provided on the surface of the housing back are exposed in the housing surface, the necessary data can be confirmed without opening the two housing sections, unlike the conventional folded type radio apparatus.

It should be noted that when the display data requires a larger screen in accordance with the kind, function and use purpose of the radio apparatus, the display sections may be provided for the back surfaces of both of the folded type first and second housing sections 10 and 20. When there is few amount of the display data, the reduction of the manufacturing cost can be attempted, if the display section is provided only for either of the first and second housing sections.

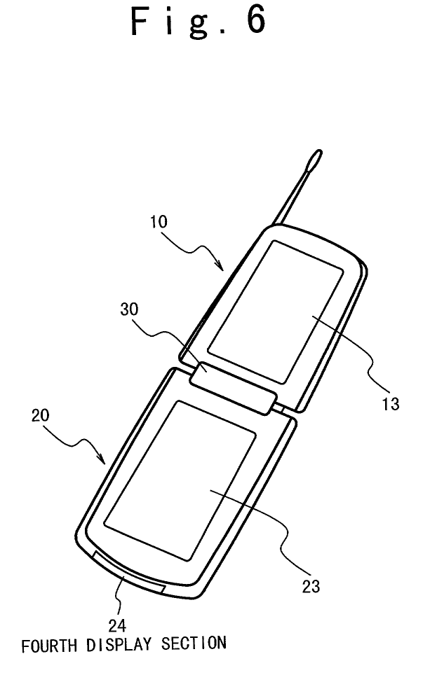

Next, the portable radio apparatus according to the third embodiment of the present invention will be described with reference to FIG. 6. FIG. 6 is a perspective view of the portable radio apparatus in the third embodiment when the portable radio apparatus is seen from the back surface.

As shown in FIG. 6, the portable radio apparatus of the third embodiment is a modification example of the above-mentioned second embodiment. In addition to the second and third display sections 13 and 23 which are provided for the back surfaces of the first and second housing sections 10 and 20, a fourth display section 24 is provided for the end surface of the second housing section 20 into the longitudinal direction.

According to the portable radio apparatus of the third embodiment having such a structure, because the fourth display section 24 is provided for the end surface of the housing section 20 in addition to the second and third display sections 13 and 23 provided on the back surfaces of the housing sections 10 and 20, a further more amount of data can be displayed.

Also, since the fourth display section 24 is provided for the end surface of the housing section 20 in this way, display data on the display section 24 can be confirmed only by looking at the housing ends in carrying state of the radio apparatus. Also, the fourth display section 24 can be simply seen without taking out the radio apparatus from a holder.

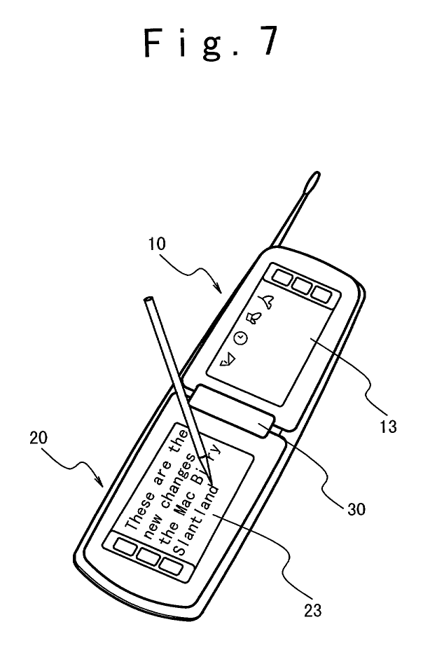

Next, the portable radio apparatus according to the fourth embodiment of the present invention will be described with reference to FIG. 7. FIG. 7 is a perspective view of the portable radio apparatus of the fourth embodiment when the portable radio apparatus of this embodiment is seen from the back surface.

As shown in FIG. 7, the portable radio apparatus of the fourth embodiment is a modification example of the above-mentioned first to third embodiment. The second and third display sections 13 and 23 provided for the back surfaces of the first and second housings 10 and 20 have a data input function. That is, the second and third display sections 13 and 23 in the fourth embodiment are composed of liquid crystal display screens in which a touch-input function is possible though pen touch, as shown in FIG. 7. By this, in the fourth embodiment, the second and third display sections 13 and 23 can be used as input means. With the input operation, the operation can be performed in the larger size of screen so that the operability of the portable radio apparatus can be further improved.

Also, like the fourth embodiment, in case that the portable radio apparatus is a folded type, the input operation can be performed in the state in which the first and second housing sections 10 and 20 are folded, without opening the radio apparatus.

It should be noted that the display section which is composed of such input means can be also applied to the portable radio apparatus which is composed of the single housing as in the above-mentioned first embodiment.

As described above, according to the portable radio apparatus of the present invention, the free space of the housing of the portable radio apparatus can be effectively utilized. Therefore, by providing the display section which is different from the display section on the front surface of the housing, a large quantity of data can be displayed at a time without compromising the portability and operability of the portable radio apparatus. Also, the display section can be used in the state in which the folded type portable radio apparatus is folded, just as it is.

What is claimed is:

1. A portable radio apparatus comprising:
a display section, a speech receiving section, a speech transmitting section and a key operation section are provided on a front surface of a housing; and
an additional display section provided on at least one of surfaces which are different from said front surface of said housing.

2. A portable radio apparatus according to claim 1, wherein said at least one of the surfaces which are different from said front surface of said housing is a back surface of said housing.

3. A portable radio apparatus according to claim 1, wherein said additional display section has a data inputting function.

4. A portable radio apparatus according to claim 1, wherein said housing comprises:
a first housing section in which said speech receiving section is provided on a front surface of said first housing section;
a second housing section in which said speech transmitting section is provided on a front surface of said second housing section; and
a hinge section for connecting said first and second housing sections such that said first and second housing sections can be folded and opened.

5. A portable radio apparatus according to claim 4, wherein said additional display section is provided on a back surface of one of said first and second housing sections.

6. A portable radio apparatus according to claim 5, wherein said additional display section has a data inputting function.

7. A portable radio apparatus according to claim 4, wherein said additional display section comprises first and second display sections which are respectively provided on back surfaces of said first and second housing sections.

8. A portable radio apparatus according to claim 7, wherein at least one of said first and second display sections has a data inputting function.

9. A folded type portable radio apparatus comprising:
a first housing section in which at least one of a first display section and key operation section is provided on a front surface of said first housing section;
a second housing section having a second display section; and
a hinge section for connecting said first and second housing sections such that said first and second housing sections can be folded and opened, and
wherein said second display section is provided such said second display section can be seen in a folded state of said first and second housing sections.

10. A folded type portable radio apparatus according to claim 9, wherein said second display section has a data inputting function.

11. A portable radio apparatus according to claim 10, wherein said first housing section is further provided with a third display section such said third display section can be seen in a folded state of said first and second housing sections.

12. A folded type portable radio apparatus according to claim 11, wherein said third display section has a data inputting function.
